(19) United States
(12) Patent Application Publication
(10) Pub. No.: US 2024/0064705 A1
(43) Pub. Date: Feb. 22, 2024

(54) BEACON FRAME OPTIMIZATION IN A WIRELESS NETWORK

(71) Applicant: NXP USA, Inc., Austin, TX (US)

(72) Inventors: Liwen Chu, San Ramon, CA (US); Kiseon Ryu, San Diego, CA (US); Hongyuan Zhang, Fremont, CA (US)

(21) Appl. No.: 18/235,712

(22) Filed: Aug. 18, 2023

Related U.S. Application Data
(60) Provisional application No. 63/371,804, filed on Aug. 18, 2022.
(60) Provisional application No. 63/380,246, filed on Oct. 20, 2022.

(51) Int. Cl. H04W 72/04

(52) U.S. Cl. CPC H04W 72/04

(57) ABSTRACT

Embodiments of a method and apparatus for wireless communications are disclosed. In an embodiment, a wireless device includes a controller configured to generate a beacon frame and a beacon extension frame that follows the beacon frame and a wireless transceiver configured to transmit the beacon frame and the beacon extension frame to devices that are compatible with a wireless communications protocol. The beacon frame carries an indication that the beacon extension frame follows the beacon frame.

### CROSS-REFERENCE TO RELATED APPLICATIONS

This application is entitled to the benefit of U.S. Provisional Patent Application Ser. No. 63/371,804, filed on Aug. 18, 2022, and U.S. Provisional Patent Application Ser. No. 63/380,246, filed on Oct. 20, 22, each of which is incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In order to announce the presence of a WLAN and/or to synchronize stations in a basic service set (BSS), an AP can periodically transmit or broadcast a beacon frame. However, beacon frames can use a significant amount of bandwidth and degrade network throughput.

### SUMMARY

Embodiments of a method and apparatus for wireless communications are disclosed. In an embodiment, a wireless device includes a controller configured to generate a beacon frame and a beacon extension frame that follows the beacon frame and a wireless transceiver configured to transmit the beacon frame and the beacon extension frame to devices that are compatible with a wireless communications protocol. The beacon frame carries or contains an indication that the beacon extension frame follows the beacon frame. Other embodiments are also disclosed.

In an embodiment, the wireless device is a wireless access point (AP).

In an embodiment, the devices that are compatible with the wireless communications protocol include non-AP station (STA) devices.

In an embodiment, the beacon extension frame contains Ultra High Reliability (UHR) information that is understandable by UHR station (STA) devices.

In an embodiment, devices that are compatible with the wireless communications protocol include non-UHR STA devices.

In an embodiment, the beacon extension frame contains information specific to Extremely High Throughput (EHT) operation or capabilities, High Efficiency (HE) operation or capabilities, Very High Throughput (VHT) operation or capabilities, or High Throughput (HT) operation or capabilities.

In an embodiment, the devices that are compatible with the wireless communications protocol are all UHR STA devices.

In an embodiment, the wireless transceiver is further configured to transmit the beacon extension frame during a critical update.

In an embodiment, the beacon extension frame contains a multi-link element.

In an embodiment, the controller is further configured to generate a second beacon extension frame, wherein the beacon extension frame carries an indication that the second beacon extension frame follows the beacon extension frame, and the wireless transceiver is further configured to transmit the second beacon extension frame to the devices after the beacon extension frame is transmitted to the devices.

In an embodiment, the wireless transceiver is further configured to transmit the beacon extension frame to the devices after the beacon frame is transmitted to the devices.

In an embodiment, the wireless communications protocol includes an Institute of Electrical and Electronics Engineers (IEEE) 802.11 protocol.

In an embodiment, the wireless communications protocol includes an Institute of Electrical and Electronics Engineers (IEEE) 802.11bn protocol.

In an embodiment, the wireless device is a component of a multi-link device (MLD).

In an embodiment, a wireless access point (AP) includes a controller configured to generate a beacon frame and a beacon extension frame that follows the beacon frame and a wireless transceiver configured to transmit the beacon frame and the beacon extension frame to non-AP devices that are compatible with a wireless communications protocol. The beacon frame carries an indication that the beacon extension frame follows the beacon frame. The beacon extension frame is transmitted to the non-AP devices after the beacon frame is transmitted to the non-AP devices.

In an embodiment, the beacon extension frame contains UHR information that is understandable by UHR STA devices.

In an embodiment, the beacon extension frame contains information specific to EHT operation or capabilities, HE operation or capabilities, VHT operation or capabilities, or HT operation or capabilities.

In an embodiment, the beacon extension frame contains EHT and UHR information that are understandable by EHT STA devices and UHR STA devices.

In an embodiment, the controller is further configured to generate a second beacon extension frame, where the beacon extension frame carries an indication that the second beacon extension frame follows the beacon extension frame, and where the wireless transceiver is further configured to transmit the second beacon extension frame to the non-AP devices after the beacon extension frame is transmitted to the non-AP devices.

In an embodiment, a method for wireless communications involves generating a beacon frame and a beacon extension frame that follows the beacon frame and transmitting the beacon frame and the beacon extension frame to devices that are compatible with a wireless communications protocol. The beacon frame carries an indication that the beacon extension frame follows the beacon frame.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link communications system in accordance with an embodiment of the invention.

FIG. 3 depicts a beacon frame and a beacon extension frame in accordance with an embodiment of the invention.

FIG. 4 depicts a combination of a beacon frame and a beacon extension frame that is not allowed in a first option.

FIG. 5 depicts a combination of a beacon frame and a beacon extension frame that is allowed in the first option.

FIG. 6 depicts a combination of a beacon frame and a beacon extension frame that is allowed in a second option.

FIG. 7 depicts another combination of a beacon frame and a beacon extension frame that is allowed in the second option.

FIG. 8 depicts an example BSS membership selector value encoding table.

FIG. 9 depicts an example format of a High Efficiency (HE) capabilities element.

FIG. 10 depicts an example format of another HE capabilities element.

FIG. 11 depicts a wireless device in accordance with an embodiment of the invention.

FIG. 12 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

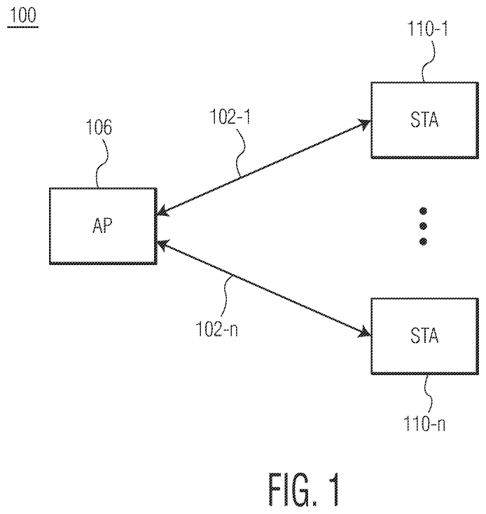

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with one STA, multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications links. In some embodiments, the wireless communications system 100 described with reference to FIG. 1 involves multi-link communications and the AP and the STA communicate through multiple communications links. Furthermore, the techniques described herein may also be applicable to each link of a multi-link communications system.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communications device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. Features of wireless communications and multi-link communication systems operating in accordance with the UHR communication protocol and/or next-generation communication protocols may be referred to herein as “non-legacy” features. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower data throughput protocols. The lower data throughput communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

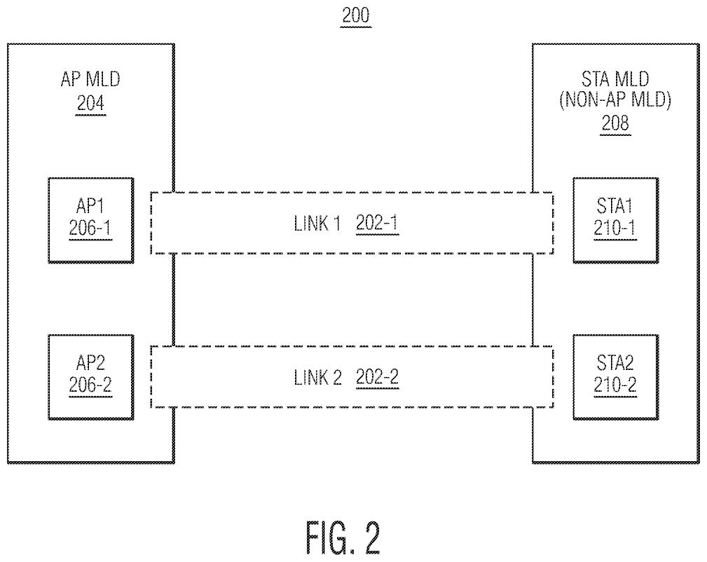

FIG. 2 depicts a multi-link communications system 200 in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD 208. The multi-link communications system is an embodiment of the wireless communications system 100 depicted in FIG. 1. In some embodiments, the multi-link communications system is a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) or legacy STA MLDs (non-UHR STA MLDs) associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two radios, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 106-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with the IEEE 802.11bn protocol.

In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 6-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 106-2 may operate in a 160 MHz BSS operating channel at 5 GHz band. Although the AP MLD 204 is shown in FIG. 2 as including two APs, other embodiments of the AP MLD 204 may include more than two APs.

In the embodiment depicted in FIG. 2, the non-AP STA multi-link device, implemented as STA MLD 208 (non-AP MLD 208), includes two radios which are implemented as non-AP STAs 210-1 and 210-2. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., Physical Layer Convergence Protocol (PLCP) Protocol Data Units (PPDUs), Beacon frames, management frames, etc.) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via multiple links 202-1 and 202-2, in other embodiments, the AP MLD 4 may communicate (e.g., wirelessly communicate) with the STA MLD 208 via more than two communication links or less than two communication links.

In order to announce the presence of a WLAN and/or to synchronize stations in a basic service set (BSS), an AP (e.g., the AP 106 depicted in FIG. 1 and/or the AP 206-1 or 206-2 depicted in FIG. 2) can periodically transmit or broadcast a beacon frame. However, a STA may discard the beacon if the beacon is too long, and beacon frames can use a significant amount of bandwidth and degrade network throughput. In some embodiments, beacon extension is used to reduce the size of beacon frames. For example, if an AP (e.g., the AP 106 depicted in FIG. 1 and/or the AP 206-1 or 206-2 depicted in FIG. 2) determines that a beacon frame may be too long and some STAs (e.g., the at least one STA 110-1, . . . , 110-n depicted in FIG. 1 and/or the STAs 210-1 and 210-2 depicted in FIG. 2) may discard the beacon frame, the AP can move some content to beacon extension (e.g., a beacon extension frame) that follows the beacon frame (e.g., is transmitted after or subsequent to the beacon frame).

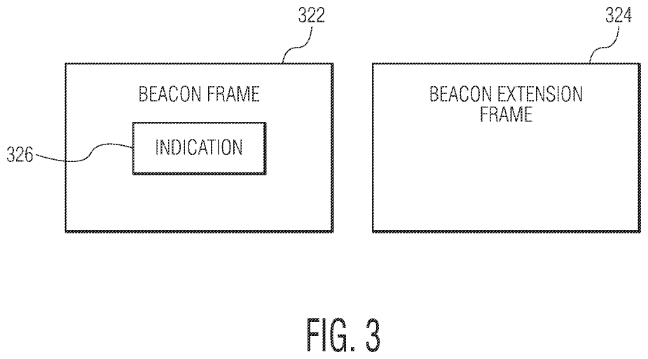

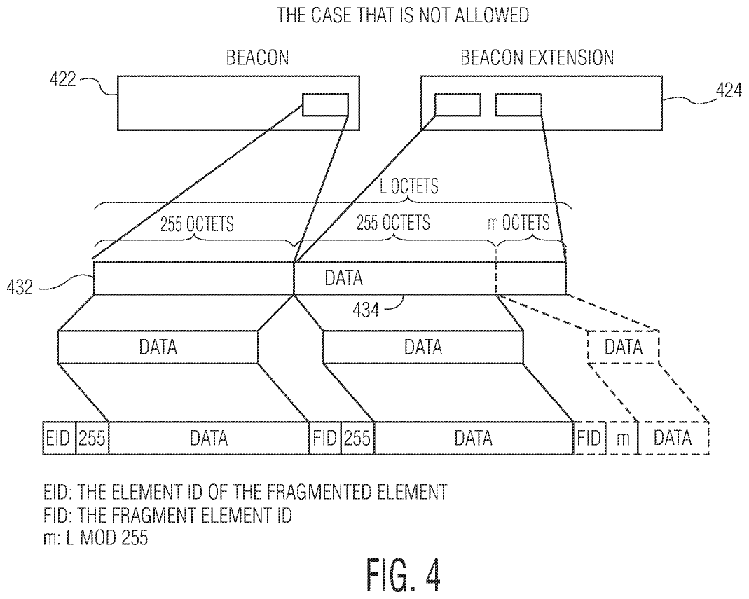

FIG. 3 depicts a beacon frame 322 and a beacon extension frame 324 in accordance with an embodiment of the invention. The beacon frame 322 and the beacon extension frame 324 may be transmitted from an AP (e.g., the AP 106 depicted in FIG. 1 and/or the AP 206-1 or 206-2 depicted in FIG. 2) to a number of non-AP STAs (e.g., the at least one STA 110-1, . . . , 110-n depicted in FIG. 1 and/or the STAs 210-1 and 210-2 depicted in FIG. 2). In the embodiment depicted in FIG. 4, the beacon extension frame 324 follows the beacon frame 322, which carries or contains an indication 326 that the beacon extension frame (or a broadcast management frame, e.g., a Probe Response frame) follows the beacon frame. The beacon extension frame can be optionally transmitted and the probe procedure can be used to acquire the BSS full information. For example, the beacon extension frame is transmitted after the beacon frame is transmitted. In some embodiments, instead of the beacon extension frame 324, a broadcast management frame (e.g., a Probe Response frame) follows the beacon frame 322 and is transmitted to non-AP STAs after the beacon frame is transmitted to the non-AP STAs. In these embodiments, the beacon frame carries or contains an indication that the broadcast management frame follows the beacon frame.

In one option, a beacon extension frame or another broadcast frame, (e.g., a broadcast Probe Response frame) carries or contains Ultra High Reliability (UHR) information that is understood or understandable by UHR STAs, and the beacon frame can carry or contain the UHR information if the length restriction allows such inclusion. In some embodiments, the beacon extension frame cannot carry the information specific to EHT operation/capabilities, HE operation/capabilities, VHT operation/capabilities, and/or HT operation/capabilities. Instead, the beacon frame needs to carry or contain information specific to EHT operation/capabilities, HE operation/capabilities, VHT operation/capabilities, and/or HT operation/capabilities with the following exception. This case is used when a legacy STA is associated with the AP. In some embodiments, if all the associated STAs need to support UHR, the information specific to EHT operation/capabilities, HE operation/capabilities, VHT operation/capabilities, High Throughput (HT) operation/capabilities can be carried or included in a beacon extension frame or another broadcast frame (e.g., a broadcast Probe Response frame) instead of in a beacon frame. With this, the beacon frame can carry or contain the most basic information, and an AP can select the no transmission of the beacon extension. Instead, the probe procedure can be used to acquire the full information of the AP if the beacon extension is not transmitted by an AP. In one embodiment, the most basic information includes Service Set Identifier (SSID), security information, Basic Service Set Identifier (BSSID) information, critical update related information (Capability Information And Status Indication field, Reduced Neighbor Report (RNR) element), Traffic indication map (TIM).

In another option, a beacon extension (e.g., a beacon extension frame) carries or contains EHT and UHR information that is understood or understandable by EHT STAs and UHR STAs, and a beacon frame can carry or contain the EHT and UHR information if the length restriction allows such inclusion. For example, a Beacon extension frame cannot or does not carry or contain the information specific to HE operation/capabilities, VHT operation/capabilities, and/or HT operation/capabilities with the following exception. For example, if all the associated STAs need to support EHT, the information specific to HE operation/capabilities, VHT operation/capabilities, HT operation/capabilities can be carried or included in a beacon extension (e.g., a beacon extension frame) instead of in a beacon frame.

In some embodiments, non/less transmission of beacon extension is implemented. In some embodiments, the Beacon frame has the indication that the AP supports the UHR while the Beacon doesn't include the UHR information, e.g., UHR Capabilities element, UHR Operation element. In one embodiment, the support of UHR is carried in one-bit subfield carried in the Extended Capabilities element. Another variant is that when the AP doesn't transmit the Beacon Extension frame and the STAs that intend to do the association etc., or receive the beacon frame indicates the UHR critical update is not carried in the beacon frame can acquire AP's full information through probe procedure (e.g., Probe Request/Response, broadcast Probe Response without soliciting). In some embodiment, the AP transmits both the Beacon and the Beacon Extension when the critical update happens where the Beacon Extension is frame that carries the critical update. In some embodiment, the AP transmits both the Beacon and the broadcast Probe Response frame when the critical update happens where the broadcast Probe Response is frame that carries the critical update.

In some embodiment, BSS operating parameters and capabilities are announced through a beacon frame and a beacon extension frame. In an embodiment, the beacon extension frame is transmitted immediately after the beacon frame. In an embodiment, the beacon extension frame does not carry or contain the information of the PHY/MAC generations that are older than UHR, e.g., HT, VHT, HE, EHT. Either the beacon frame or the beacon extension frame can carry or contain the information of the PHY/MAC generations that are older than UHR. In some embodiments, the critical update flag and nontransmitted Basic Service Set Identifier (BSSID) critical update flag are applied to the information of the beacon frame and the beacon extension frame. In some embodiments, one element and its fragment elements cannot be separately transmitted in a beacon frame and a beacon extension. In some embodiments, an AP can transmit the beacon frame only (e.g., when the AP does not accept the further association and there is no critical update being carried by or included in the beacon extension frame).

Some examples of element fragmentation versus beacon extension are described as follows. For example, if an element cannot carry or contain all the required information because of element length restriction, the information is carried or contained in one related element with length 255 and one or multiple fragment elements.

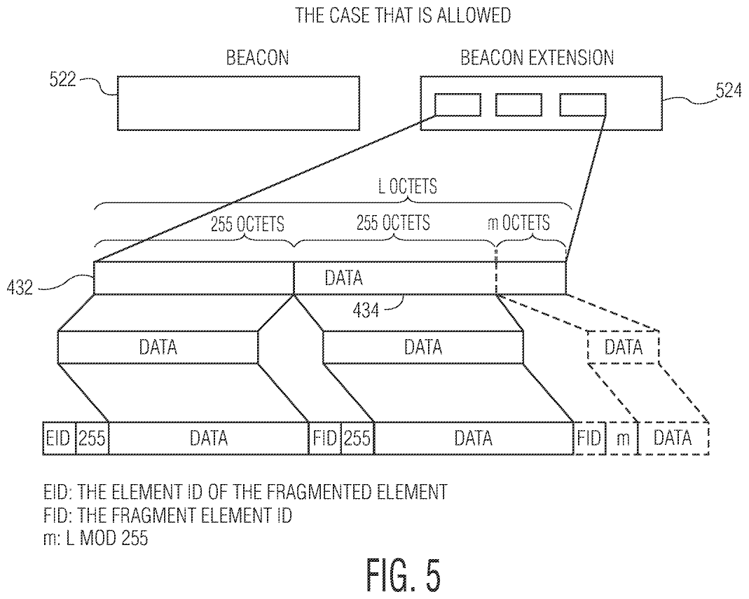

In a first option, when a beacon and a beacon extension are used to carry or contain an AP's capabilities, BSS operation parameters, an element and its fragment elements cannot be carried or contained in both the beacon and the beacon extension. FIG. 4 depicts a combination of a beacon frame 422 and a beacon extension frame 424 that is not allowed in the first option. In the embodiment depicted in FIG. 4, the beacon frame 422 includes a first fragment 432 of data while the beacon extension frame 424 includes a second fragment 434 of data (L, m being positive integers). FIG. 5 depicts a combination of a beacon frame 522 and a beacon extension frame 524 that is allowed in the first option. In the embodiment depicted in FIG. 5, the beacon extension frame includes the element whose information is fragmented, both the first fragment 432 of the information being fragmented and the second fragment 434 of the information being fragmented.

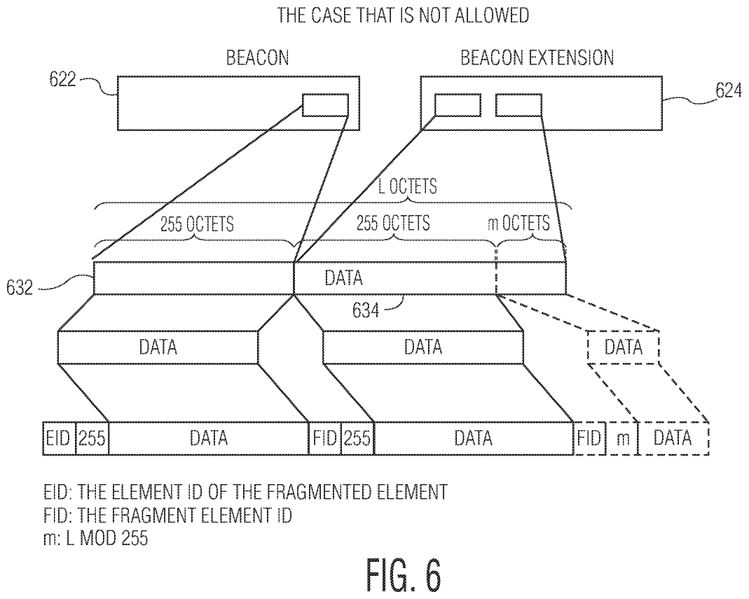

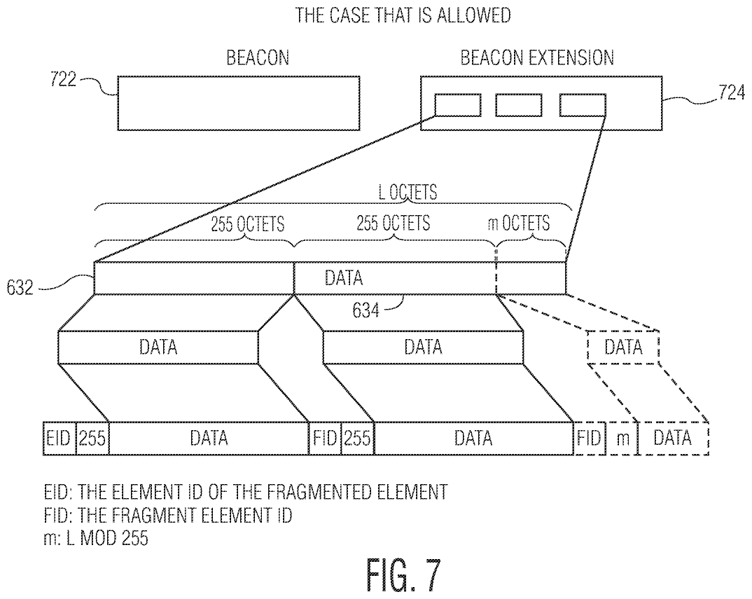

In a second option, when a beacon and a beacon extension are used to carry or contain an AP's capabilities, BSS operation parameters, an element and its fragment elements can be carried or contained in both the beacon and the beacon extension. FIG. 6 depicts a combination of a beacon frame 622 and a beacon extension frame 624 that is allowed in the second option. In the embodiment depicted in FIG. 6, the beacon frame 622 includes an element of the data that is fragmented, a first fragment 632 of data being fragmented while the beacon extension frame 624 includes a second fragment 634 of data being fragmented (L, m being positive integers). FIG. 7 depicts another combination of a beacon frame 722 and a beacon extension frame 724 that is allowed in the second option. In the embodiment depicted in FIG. 7, the beacon extension frame 724 includes an element of the data that is fragmented, both the first fragment 632 of the data being fragmented and the second fragment 634 of the data being fragmented.

Some examples of critical update are described as follows. In some embodiments, the Critical Update Flag, Nontransmitted BSSIDs Critical Update Flag, BSS parameters change count (BPCC), All Updates included that are carried in a beacon are applied to the information in the beacon, and the beacon extension. For example, when all the information related to BSS Parameters Change Count of an AP affiliated with an AP MLD is carried or contained in a beacon and/or a beacon extension with Critical Update Flag being equal to 1, the All Updates included related to the AP are set to 1. In an example, when either a beacon or a beacon extension of an AP in a link carries or contains the critical update, the BPCC of the AP in the AP's Beacon is increased and the Critical Update Flag of the AP in the AP's Beacon is set 1. In an example, when either a beacon or a beacon extension of an AP in a link carries or contains the critical update, the BPCC of the AP carried in another link is increased. In some embodiments, if a non-AP STA receives a beacon frame that indicates the existence of a beacon extension frame and All Updates Included being equal to 1 and the non-AP STA does not receive the following beacon extension frame, the non-AP STA may transmit a Probe Request frame or other management frame to request transmission of the information at least in the beacon extension frame. In this case, the non-AP STA may include the information that the beacon extension frame has not been received. In some embodiments, if a non-AP STA receives a beacon frame that indicates the existence of a beacon extension frame and the non-AP STA does not receive the following beacon extension frame, the non-AP STA may transmit a Probe Request frame or other management frame to request transmission of the information at least in the beacon extension frame.

Some examples of multi-link element are described as follows. In some embodiments, the basic (or other variant) multi-link element may become longer in UHR and a beacon cannot carry or contain the basic (or other variant) multi-link element and other BSS parameters. In an embodiment, the Multi-Link element can be carried or contained in a beacon extension. In an embodiment, a first basic multi-link element with a MLD ID and a second basic multi-link element with the same MLD ID are used. In an embodiment, the second multi-link element includes the UHR update to multi-link element, and is carried or contained in a beacon extension. In an embodiment, the multi-link element with EHT and UHR related information can be carried or contained in a beacon.

Some examples of multiple beacon extension are described as follows. In some embodiments, more than one beacon extension frames are transmitted based on the indication of the existence of the beacon extension. For example, if a beacon frame indicates the existence of beacon extension, a first beacon extension frame follows the beacon frame. If the first beacon extension frame indicates the existence of beacon extension, a second beacon extension frame follows the first beacon extension frame, etc. In some embodiments, if a non-AP STA receives a beacon frame or a beacon extension frame that indicates the existence of beacon extension and the non-AP STA does not receive the following beacon extension frame, the non-AP STA may transmit a Probe Request frame or other management frame to request transmission of the beacon extension frame that has not been received by the non-AP STA. In this case, the non-AP STA may include the information of which Beacon extension frame has not been received (e.g., first beacon extension or second beacon extension, etc.).

Some examples of beacon extension based on the version of standard are described as follows. In some embodiments, beacon extension frame(s) can carry or contain each standard version of operation/capabilities elements. For example, a beacon frame indicating the existence of beacon extension may carry or contain the information specific to HE operation/capabilities, VHT operation/capabilities, and/or HT operation/capabilities. A first Beacon extension frame may carry or contain the information specific to UHR operation/capabilities. If the first beacon extension frame indicates the existence of Beacon extension, a second beacon extension frame may carry or contain the information specific to NG-UHR (NG referring to next generation) operation/capabilities, i.e., the operation/capabilities of the next generation of UHR. If the first beacon extension frame indicates no further existence of Beacon extension, the first beacon extension frame may carry or contain the information specific to UHR operation/capabilities. A beacon frame and the following beacon extension frame may be transmitted in a Short Interframe Space (SIFS). If a non-AP STA receives a beacon frame or a beacon extension frame that indicates the existence of beacon extension and the non-AP STA does not receive the following beacon extension frame, the non-AP STA may transmit a Probe Request frame or other management frame to request transmission of the beacon extension frame that has not been received by the non-AP STA. In this case, the non-AP STA may include the information of which beacon extension frame has not been received (e.g., first Beacon extension or second Beacon extension, etc.).

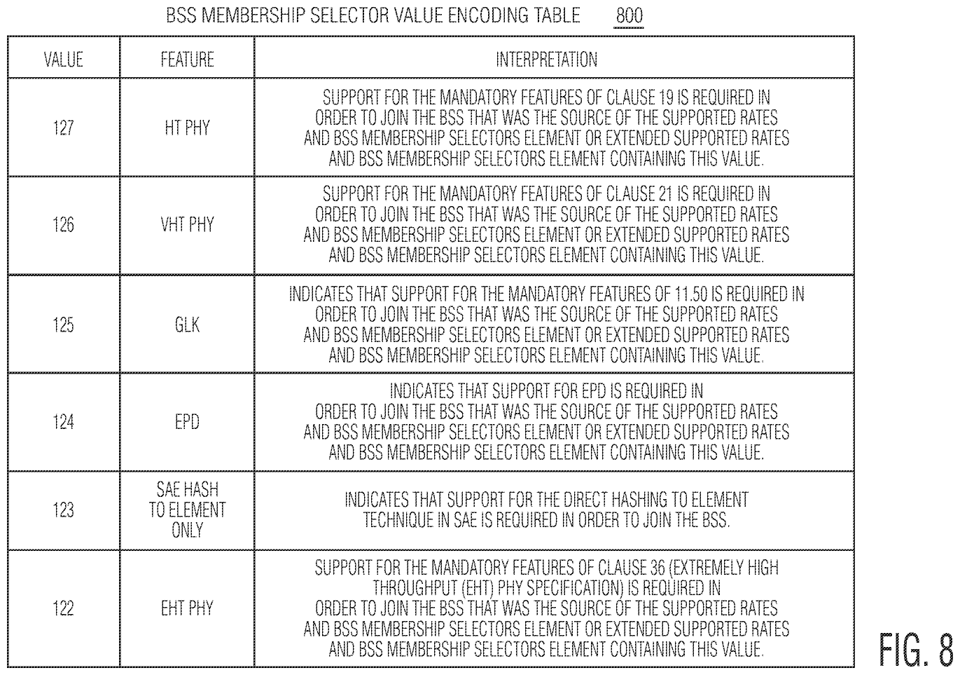

In some embodiments, a beacon does not carry or contain unnecessary information. For example, through a BSS membership selector, an AP may announce the PHY generation that must be supported in order to join the BSS. FIG. 8 depicts an example BSS membership selector value encoding table 800. In the BSS membership selector value encoding table 800 depicted in FIG. 8, a feature HT PHY has a value of 127, a feature VHT PHY has a value of 126, a feature General Link (GLK) has a value of 125, a feature EtherType protocol discrimination (EPD) has a value of 124, a feature Simultaneous Authentication of Equals (SAE) Hash to Element only has a value of 123, and a feature EHT PHY has a value of 122.

In an embodiment, a beacon needs to carry or contain the HT, VHT, HE, EHT Capabilities, Operation elements where some fields in those elements apply to HT, VHT, HE EHT only. In a first solution in non-UHR (HT, VHT, HE EHT) capabilities element, the fields that are specific to the respective PHY generation are optional fields. In an embodiment, in non-UHR (HT, VHT, HE EHT) Operation element, the fields that are specific to the respective PHY generation are optional fields. In a second solution, in the new UHR Capabilities element and the Capabilities elements of the future generations, the fields that are specific to the PHY generation are optional fields. In an embodiment, in the new UHR Operation element and the Operation elements of the future generations, the fields that are specific to the PHY generation are optional fields.

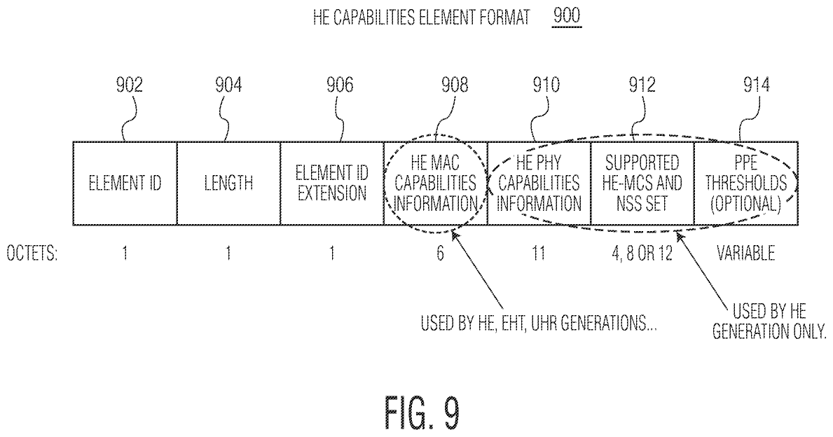

FIG. 9 depicts an example format of an HE capabilities element 900. In the embodiment depicted in FIG. 9, the HE capabilities element 900 includes an element identification (ID) field 902 (e.g., one-octet) that may contain identification information regarding which specific element this element represents, an element length field 904 (e.g., one-octet) that may contain element length information, an element ID extension field 906 (e.g., one-octet) that may contain ID extension information, a HE MAC capabilities information field 908 (e.g., six-octet) that may contain information regarding HE MAC capabilities and may be used by HE, EHT, UHR generations, a HE PHY capabilities information field 910 (e.g., eleven-octet) that may contain information regarding HE PHY capabilities, a supported HE Modulation Coding Scheme (MCS) and Number of Spatial Streams (NSS) set field 912 (e.g., four-octet, eight-octet or twelve-octet) that may contain information regarding supported HE MCS and NSS set and may be used by HE generation only, and an optional variable (physical layer (PHY) packet extension) PPE thresholds field 914 (e.g., zero-octet, three-octet or five-octet) that may contain PPE threshold information. In some embodiments, the HE capabilities element 900 further includes some reserved (sub)field.

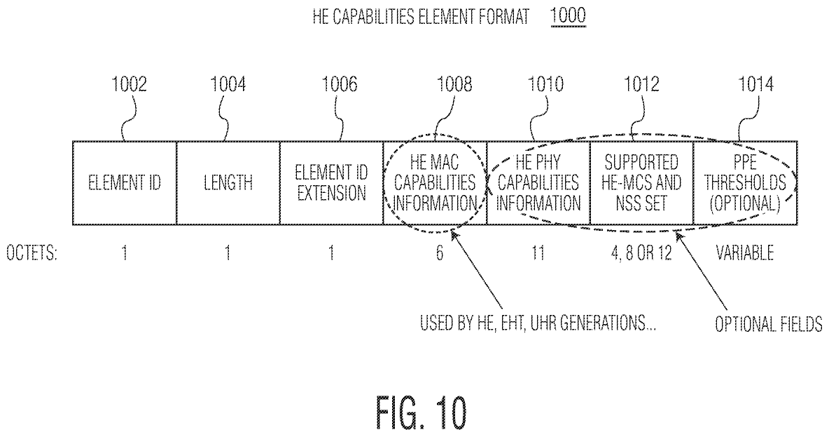

FIG. 10 depicts an example format of another HE capabilities element 1000. In the embodiment depicted in FIG. 10, the HE capabilities element 1000 includes an element identification (ID) field 1002 (e.g., one-octet) that may contain identification information regarding which specific element this element represents, an element length field 1004 (e.g., one-octet) that may contain element length information, an element ID extension field 1006 (e.g., one-octet) that may contain ID extension information, a HE MAC capabilities information field 1008 (e.g., six-octet) that may contain information regarding HE MAC capabilities and may be used by HE, EHT, UHR generations, an optional HE PHY capabilities information field 1010 (e.g., eleven-octet) that may contain information regarding HE PHY capabilities, an optional supported HE MCS and NSS set field 1012 (e.g., four-octet, eight-octet or twelve-octet) that may contain information regarding supported HE MCS and NSS set, and an optional variable PPE thresholds field 1014 (e.g., zero-octet, three-octet or five-octet) that may contain PPE threshold information. In some embodiments, the HE capabilities element 1000 further includes some reserved (sub)field.

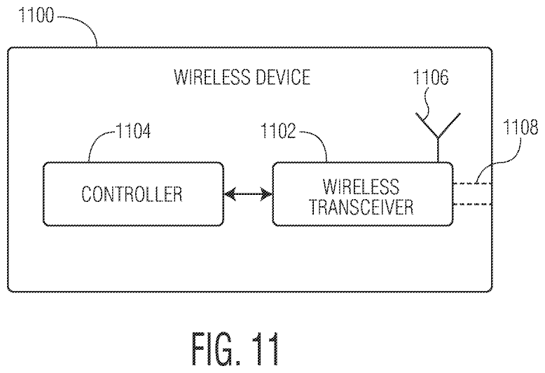

FIG. 11 depicts a wireless device 1100 in accordance with an embodiment of the invention. The wireless device 1100 can be used in the wireless communications system 100 depicted in FIG. 1 and the multi-link communications system 200 depicted in FIG. 2. For example, the wireless device 1100 may be an embodiment of the AP 106 depicted in FIG. 1, the STA 110-1, . . . , 110-n depicted in FIG. 1, the APs 206-1, 206-2 depicted in FIG. 2, and/or the stations STAs 210-1, 210-2 depicted in FIG. 2. However, the AP 106 depicted in FIG. 1, the STA 110-1, . . . , 110-n depicted in FIG. 1, the APs 206-1, 206-2 depicted in FIG. 2, and the stations STAs 210-1, 210-2 depicted in FIG. 2 are not limited to the embodiment depicted in FIG. 11.

In the embodiment depicted in FIG. 11, the wireless device 1100 includes a wireless transceiver 1102, a controller 1104 operably connected to the wireless transceiver, and at least one antenna 1106 operably connected to the wireless transceiver. In some embodiments, the wireless device 1100 may include at least one optional network port 1108 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1100 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In accordance with an embodiment of the invention, the controller 1104 is configured to generate a beacon frame and a beacon extension frame that follows the beacon frame, where the beacon frame carries or contains an indication that the beacon extension frame follows the beacon frame. In this embodiment, the wireless transceiver 1102 is configured to transmit the beacon frame and the beacon extension frame to devices that are compatible with a wireless communications protocol. In some embodiments, the wireless device is a wireless access point (AP). In some embodiments, the devices that are compatible with the wireless communications protocol include non-AP station (STA) devices. In some embodiments, the beacon extension frame contains Ultra High Reliability (UHR) information that is understandable by UHR STAs. In some embodiments, the beacon extension frame contains information specific to Extremely High Throughput (EHT) operation or capabilities, High Efficiency (HE) operation or capabilities, Very High Throughput (VHT) operation or capabilities, or High Throughput (HT) operation or capabilities. In some embodiments, the beacon extension frame contains EHT and UHR information that are understandable by EHT STAs and UHR STAs. In some embodiments, the beacon extension frame contains a multi-link element. In some embodiments the controller is further configured to generate a second beacon extension frame, where the beacon extension frame carries an indication that the second beacon extension frame follows the beacon extension frame, and the wireless transceiver is further configured to transmit the second beacon extension frame to the devices after the beacon extension frame is transmitted to the devices. In some embodiments, the wireless transceiver is further configured to transmit the beacon extension frame to the devices after the beacon frame is transmitted to the devices. In some embodiments, the wireless device is compatible with an Institute of Electrical and Electronics Engineers (IEEE) 802.11 protocol. In some embodiments, the wireless device is compatible with an Institute of Electrical and Electronics Engineers (IEEE) 802.11bn protocol. In some embodiments, the wireless device is a component of a multi-link device (MLD).

In accordance with an embodiment of the invention, the wireless device 1100 is a wireless AP. In this embodiment, the controller 1104 is configured to generate a beacon frame and a beacon extension frame that follows the beacon frame, where the beacon frame carries an indication that the beacon extension frame follows the beacon frame, and the wireless transceiver 1102 is configured to transmit the beacon frame and the beacon extension frame to non-AP devices that are compatible with a wireless communications protocol, where the beacon extension frame is transmitted to the non-AP devices after the beacon frame is transmitted to the non-AP devices. In some embodiments, the beacon extension frame contains UHR information that is understandable by UHR STAs. In some embodiments, the beacon frame contains the basic information and beacon extension frame contains information specific to EHT operation or capabilities, HE operation or capabilities, VHT operation or capabilities, or HT operation or capabilities. In some embodiments, the beacon extension frame contains EHT and UHR information that are understandable by EHT STAs and UHR STAs. In some embodiments, the controller is further configured to generate a second beacon extension frame, where the beacon extension frame carries an indication that the second beacon extension frame follows the beacon extension frame, and the wireless transceiver is further configured to transmit the second beacon extension frame to the non-AP devices after the beacon extension frame is transmitted to the non-AP devices.

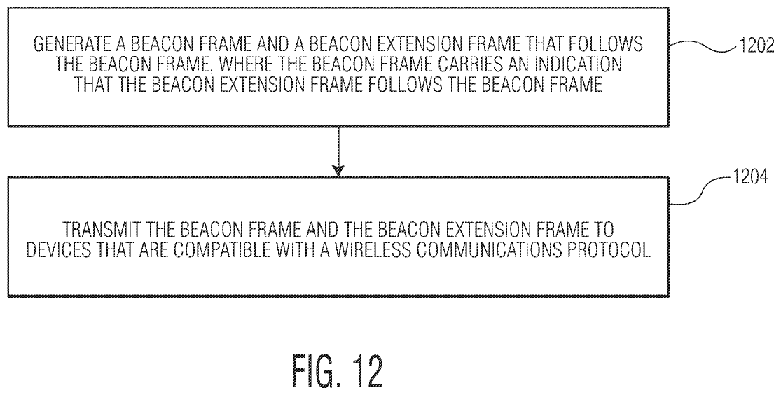

FIG. 12 is a process flow diagram of a method for wireless communications in accordance with an embodiment of the invention. At block 1202, a beacon frame and a beacon extension frame that follows the beacon frame are generated, where the beacon frame carries an indication that the beacon extension frame follows the beacon frame. At block 1204, the beacon frame and the beacon extension frame are transmitted to devices that are compatible with a wireless communications protocol. In some embodiments, in a wireless access point (AP), the beacon frame and the beacon extension frame that follows the beacon frame are generated, and from the wireless AP, the beacon frame and the beacon extension frame are transmitted to the devices. In some embodiments, the devices that are compatible with the wireless communications protocol include non-AP STA devices. In some embodiments, the beacon extension frame contains UHR information that is understandable by UHR STAs. In some embodiments, the beacon frame carries the basic information of a BSS, and the beacon extension frame contains information specific to EHT operation or capabilities, HE operation or capabilities, VHT operation or capabilities, or HT operation or capabilities. In some embodiments, the beacon frame is optionally transmitted. In some embodiments, the beacon extension frame contains EHT and UHR information that are understandable by EHT STAs and UHR STAs. In some embodiments, the beacon extension frame contains a multi-link element. In some embodiments, the beacon extension frame is transmitted to the devices after the beacon frame is transmitted to the devices. In some embodiments, the wireless communications protocol includes an IEEE 802.11 protocol, e.g., an IEEE 802.11bn protocol.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate a beacon frame and a beacon extension frame that follows the beacon frame, wherein the beacon frame carries an indication that the beacon extension frame follows the beacon frame; and
a wireless transceiver configured to transmit the beacon frame and the beacon extension frame to a plurality of devices that are compatible with a wireless communications protocol.

2. The wireless device of claim 1, wherein the wireless device is a wireless access point (AP).

3. The wireless device of claim 2, wherein the devices that are compatible with the wireless communications protocol comprise a plurality of non-AP station (STA) devices.

4. The wireless device of claim 1, wherein the beacon extension frame contains Ultra High Reliability (UHR) information that is understandable by a plurality of UHR station (STA) devices.

5. The wireless device of claim 4, where the devices that are compatible with the wireless communications protocol include non-UHR STA devices.

6. The wireless device of claim 1, wherein the beacon extension frame contains information specific to Extremely High Throughput (EHT) operation or capabilities, High Efficiency (HE) operation or capabilities, Very High Throughput (VHT) operation or capabilities, or High Throughput (HT) operation or capabilities.

7. The wireless device of claim 6, where the devices that are compatible with the wireless communications protocol are all Ultra High Reliability (UHR) station (STA) devices.

8. The wireless device of claim 1, wherein the wireless transceiver is further configured to transmit the beacon extension frame during a critical update.

9. The wireless device of claim 1, wherein the beacon extension frame contains a multi-link element.

10. The wireless device of claim 1, wherein the controller is further configured to generate a second beacon extension frame, wherein the beacon extension frame carries an indication that the second beacon extension frame follows the beacon extension frame, and wherein the wireless transceiver is further configured to transmit the second beacon extension frame to the devices after the beacon extension frame is transmitted to the devices.

11. The wireless device of claim 1, wherein the wireless transceiver is further configured to transmit the beacon extension frame to the devices after the beacon frame is transmitted to the devices.

12. The wireless device of claim 1, wherein the wireless communications protocol comprises an Institute of Electrical and Electronics Engineers (IEEE) 802.11 protocol.

13. The wireless device of claim 1, wherein the wireless communications protocol comprises an Institute of Electrical and Electronics Engineers (IEEE) 802.11bn protocol.

14. The wireless device of claim 1, wherein the wireless device is a component of a multi-link device (MLD).

15. A wireless access point (AP) comprising:
a controller configured to generate a beacon frame and a beacon extension frame that follows the beacon frame, wherein the beacon frame carries an indication that the beacon extension frame follows the beacon frame; and
a wireless transceiver configured to transmit the beacon frame and the beacon extension frame to a plurality of non-AP devices that are compatible with a wireless communications protocol, wherein the beacon extension frame is transmitted to the non-AP devices after the beacon frame is transmitted to the non-AP devices.

16. The wireless AP of claim 15, wherein the beacon extension frame contains Ultra High Reliability (UHR) information that is understandable by a plurality of UHR station (STA) devices.

17. The wireless AP of claim 15, wherein the beacon extension frame contains information specific to Extremely High Throughput (EHT) operation or capabilities, High Efficiency (HE) operation or capabilities, Very High Throughput (VHT) operation or capabilities, or High Throughput (HT) operation or capabilities.

18. The wireless AP of claim 15, wherein the beacon extension frame contains Extremely High Throughput (EHT) and Ultra High Reliability (UHR) information that are understandable by a plurality of EHT station (STA) devices and UHR STA devices.

19. The wireless AP of claim 15, wherein the controller is further configured to generate a second beacon extension frame, wherein the beacon extension frame carries an indication that the second beacon extension frame follows the beacon extension frame, and wherein the wireless transceiver is further configured to transmit the second beacon extension frame to the non-AP devices after the beacon extension frame is transmitted to the non-AP devices.

20. A method for wireless communications, the method comprising:
generating a beacon frame and a beacon extension frame that follows the beacon frame, wherein the beacon frame carries an indication that the beacon extension frame follows the beacon frame; and
transmitting the beacon frame and the beacon extension frame to a plurality of devices that are compatible with a wireless communications protocol.
